(19) United States
(12) Patent Application Publication
(10) Pub. No.: US 2023/0111787 A1
(43) Pub. Date: Apr. 13, 2023

(54) Personal Massage Device Having at Least One Sealed Chamber

(71) Applicant: Uccellini Inc., Bend, OR (US)

(72) Inventors: Douglas S. Layman, Bend, OR (US); Mazie Houchens, Corvallis, OR (US); Blake Michael Larkin, Eugene, OR (US); Ryan Peter Riehl, Bend, OR (US); Avery Dawn Smith, Albany, OR (US); Nicholas Ress, Bend, OR (US); Mark Hazelton, Philomath, OR (US)

(21) Appl. No.: 17/963,155

(22) Filed: Oct. 10, 2022

Related U.S. Application Data
(60) Provisional application No. 63/254,517, filed on Oct. 11, 2021.

(51) Int. Cl. A61H 19/00

(52) U.S. Cl. CPC A61H 19/34

(57) ABSTRACT

Embodiments of the present invention relate to an improved stimulation device. More specifically, the simulation device comprises a cup formed of a flexible resilient material, with a cavity, and opening and a flexible cap which may swell and unswell in response to internal pressure changes in the cavity of the device to match a user's preferences.

### CROSS-REFERENCE TO RELATED APPLICATIONS

The present patent document claims priority to U.S. provisional patent application Ser. No. 63/254,517 titled “PERSONAL MESSAGE DEVICE HAVING AT LEAST ONE SEALED CHAMBER.” The entire disclosure of such application is incorporated herein by reference.

### FIELD

Embodiments of the invention relate to a stimulation device, and more particularly, to an air pressure field stimulation device.

### BACKGROUND

Stimulation of skin has many beneficial effects, including raising blood flow in the area, and stimulating nerve endings. In addition, on a human body, a vulva includes organs including a clitoris, mons pubis, labia majora, and labia minora surrounding the vagina. The glans clitoris is a portion of the clitoris that is on the vulva, external to the vagina. The glans clitoris is sexually responsive, having thousands of nerve endings. The vulva (and vagina) is sexually responsive as well. Stimulation of a person's glans clitoris increases blood flow to the area and provides sexual pleasure. There exists a need for improvements in devices that can provide increased stimulation.

### SUMMARY

In embodiments, there is provided a cap for use with or in combination with one or more varieties of stimulation devices. In one embodiment, the stimulation device is of the sort comprising: a cup formed of a flexible resilient material comprising a cavity; and a driver, the driver comprising: a plate disposed on an underside of the cup; a cam disposed adjacent to the plate; a cam pin extending from the cam; a bearing disposed on the cam pin; a motor mechanically coupled to the cam; and a lifter mechanically coupled to the bearing, said lifter also mechanically coupled to the plate.

In one embodiment, the stimulation device is of the sort comprising: a cup formed of a flexible resilient material comprising a cavity; a driver, the driver comprising: a plate disposed on an underside of the cup; a cam disposed adjacent to the plate; a cam pin extending from the cam; a bearing disposed on the cam pin; a motor mechanically coupled to the cam; and a lifter mechanically coupled to the bearing, said lifter also mechanically coupled to the plate; a processor;

and a memory containing instructions that when executed by the processor cause the driver to vary a volume of the cavity of the cup from a first volume to a second volume.

In one embodiment, the stimulation device is of the sort comprising: a cup having a cavity, the cup formed of a flexible resilient material, the cavity having an opening; and a driver configured to vary a volume of the cavity through an operation cycle; wherein a top surface of the cup is joined to side walls of the cup at a inflection point; wherein the top of the cup is configured and disposed to undergo expansion and contraction during the operation cycle.

In one embodiment, the stimulation device is of the sort comprising: a cup formed of a flexible resilient material, and having a cavity, wherein the top of the cup is joined with outer side walls of the cup at inflection points; a driver; a processor; and a memory containing instructions that when executed by the processor cause the driver to vary a volume of the cavity of the cup from a first volume to a second volume; wherein the top of the cup is configured to swell on a surface extending between the inflection points during variation from the first volume to the second volume; and wherein the top of the cup is configured to unswell on the surface during variation from the second volume to the first volume.

In one embodiment, the stimulation device is of the sort comprising: a cup formed of a flexible resilient material, and having a cavity, wherein a top of the cup is joined to side walls of the cup at inflection points; a driver; a processor; and a memory containing instructions that when executed by the processor cause the driver to contract and expand a volume of the cavity of the cup; wherein the top of the cup is configured to swell on a surface extending between the inflection points during contraction; and wherein the top of the cup is configured to unswell on the surface during expansion.

In one or more embodiments, a cap or cover is provided to the stimulation device as an optionally removable seal which contacts skin and covers the chamber of the cup, and wherein the seal can be convex, concave, or flat.

### BRIEF DESCRIPTION OF THE DRAWINGS

FIG. 1A is a perspective view of a cup in accordance with some embodiments of the present invention.

FIG. 1B shows a front view of the cup of FIG. 1A.

FIG. 1C is a side view of the cup of FIG. 1A.

FIG. 1D shows a rear view of the cup of FIG. 1A.

FIG. 1E is a bottom-up view of the cup of FIG. 1A.

FIG. 2A shows a side cutaway view indicating details of a cup in accordance with disclosed embodiments.

FIG. 2B shows a perspective cutaway view indicating details of a cup in accordance with disclosed embodiments.

FIG. 2C shows a partial top-down view of the embodiment of FIGS. 2A and 2B.

FIG. 3A shows a cutaway view of driver components.

FIG. 3B shows additional details of the pressure field stimulation device

FIG. 4A shows a cross-sectional view of an embodiment of the present invention with a cap.

FIG. 4B shows a cross-sectional view of another embodiment of the present invention with a cap.

FIG. 5A shows the outer cup portion in an unswelled position.

FIG. 5B shows the outer cup portion in a swelled position.

FIG. 6A shows a front cross-section view of an outer cup portion/sleeve in an unswelled position.

FIG. 6B shows a front cross-section view of an outer cup portion/sleeve in a swelled position.

### DETAILED DESCRIPTION

Disclosed embodiments provide an improved stimulation device. Embodiments of the improved stimulation device include a cup and a driver. The cup has a cavity surrounded by a rim. In use, a user positions the rim such that an opening to the cavity is over an area of a user's body to be stimulated (for example, the clitoris or other skin). A sealed, or substantially-sealed, chamber is formed by the cavity walls and the user's body (skin surrounding the clitoris or other body part). The sealed, or substantially-sealed chamber may alternatively be covered with a cap. The cap may be convex, concave or flat. The seal cap may be permanently affixed to the device or removable. The cap may be removeable as part of an assembly or plug. The portion of the cap touching a user may have bumps, ridges, or other patterns depending on the user's preferences. The cap will be a portion of the device that touches a user's body and will preferably be made of a flexible, elastomeric material to allow the cap to stretch in response to a force and return to its original shape when the force is no longer applied. This will allow the cap to expand or contract as the interior pressure of the chamber changes, according to the preference of a user.

A cap which seals the chamber allows the chambers to have varying volumes and thereby deliver differing pressures to a user. The cap can further be adjusted to achieve the desired stimulation, contact firmness and frequency of touch by a user. This is advantageous because such variability mimics human contact. The cap can be made of soft flexible materials to conform to a user's body parts and to allow stimulation to be targeted and remain on a desired location. A harder, stiffer material can also be used for the cap. Harder, stiffer materials allow users to apply more force. A cap which seals the chambers can also be compressed or expanded to meet a user's needs. Further, multiple sealed chambers allow a user to simulate a variety of human touches and can be customized to various sizes, intensities, and motions to meet a user's preferences. The flexibility of the cap allows it to reach crevices on the user's body according to a user's preferences. The cap can be substantially concave, substantially convex, or substantially flat depending on the expansion or contraction of the cap, and according to a user's preferences.

A driver is configured to vary a volume of the cavity of the cup from a first volume to a second volume, and from the second volume to the first volume. The driver is configured to repeat such operation cycle. In some embodiments, the second volume is smaller than the first volume, though this is not meant to be limiting. In some embodiments, the cup has a buckle region, which collapses and springs back out during volume changes. The springing out of the buckle region produces a “thud” or “thump” (used interchangeably herein), which is imparted to the user. In some embodiments, the stimulation device is a sex toy. In some embodiments, the driver is connected to a wall that is part of the sealed chamber. In some embodiments, the driver is in direct contact with the sealed chamber. In some embodiments, the driver is separated from the sealed chamber to apply pressure pulses. In some embodiments the pressure pulses transfer to the portion of the cap touching the body of a user. In some embodiments, the stimulation device is a medical device.

Reference throughout this specification to “one embodiment,” “an embodiment,” “some embodiments”, “embodiments,” or similar language means that a particular feature, structure, or characteristic described in connection with the embodiment is included in at least one embodiment of the present invention. Thus, appearances of the phrases “in one embodiment,” “in an embodiment,” “in some embodiments”, “in embodiments,” and similar language throughout this specification may, but do not necessarily, all refer to the same embodiment.

Moreover, the described features, structures, or characteristics of the invention may be combined (“mixed and matched”) in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, and/or elements.

For the purposes of disclosure, the word, “substantially” is defined as “for the most part”. It means “to a great extent,” but having some room for some minor variation.

Embodiments of the present invention comprise an apparatus to be used in addition to or in combination with a pressure field stimulation device of the type described in U.S. Pat. No. 11,185,463, which is incorporated by reference herein in its entirety.

Descriptions of exemplary pressure field stimulation devices suitable to and/or used as part of the present invention are described below, along with certain embodiments of the present invention.

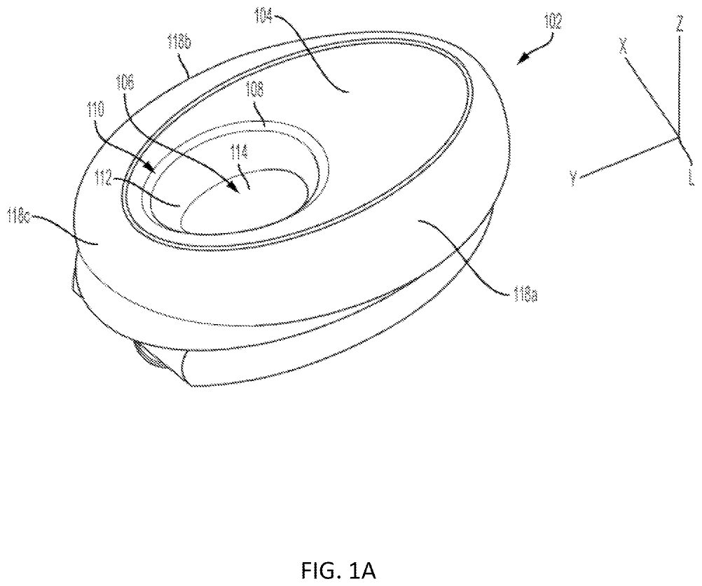

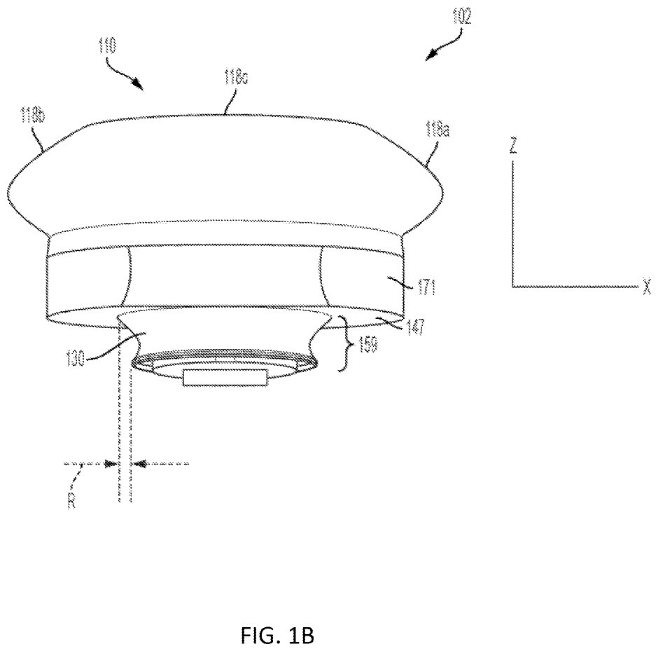

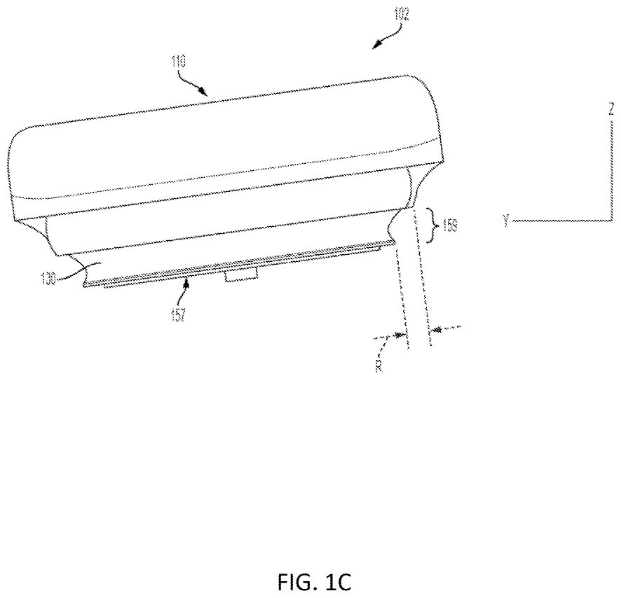

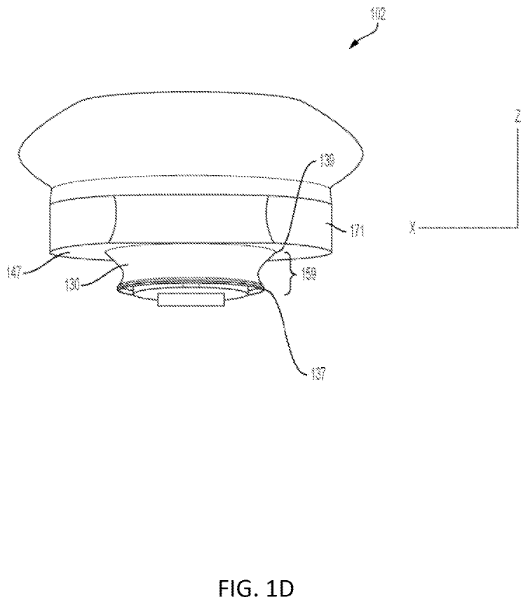

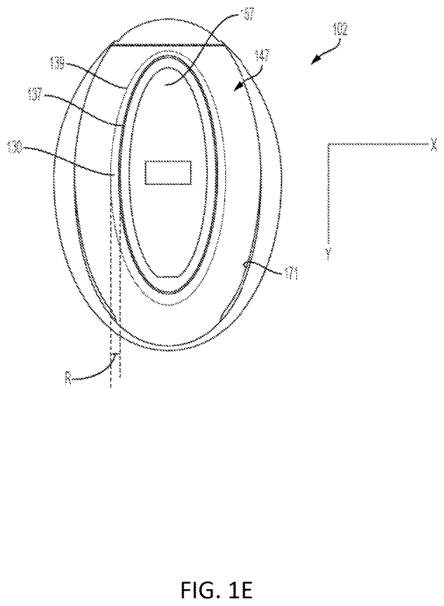

FIGS. 1A-1E show various views of an example cup 102 in accordance with some embodiments of the invention. In such figures, a legend “L” is used to indicate orientation of the various views of disclosed embodiments with respect to an X, Y, and Z axis.

FIG. 1A is a perspective view of the example cup 102 in accordance with some embodiments of the present invention. Cup 102 includes a cavity 106. In some embodiments, cavity 106 is sized and configured to fit over a region of skin of a user's body. In some embodiments, the cavity is sized and configured to fit over the region of skin on a vulva surrounding a glans clitoris of a user (note that although described herein with respect to clitoral stimulation, it should be recognized that embodiments may be used for stimulation of any suitable body part, e.g., an ear). The cavity may be further enclosed by a cap which is articulated by a driver and which contacts skin. Cavity 106 has a rim 108 defining an opening 110 of the cavity. Cavity 106 is defined by an interior lateral wall 112 and a base 114 (bottom in the orientation shown). The lateral wall 112 and base 114 may together be a single continuous substantially-rounded concave wall, or may include edges between flat surfaces. The cavity 106 may be any suitable shape. In some embodiments, cavity 106 is oval in shape as shown here. In some embodiments, lateral wall 112 and base 114 are comprised of a single continuous material with the cup 102.

The cup's cavity 106 is adapted such that when rim 108 is placed on the skin of a user with the opening 110 over the area to be stimulated, a chamber filled with air is formed among the cavity walls 112, base 114, and the user's skin. The chamber is preferably sealed or substantially-sealed.

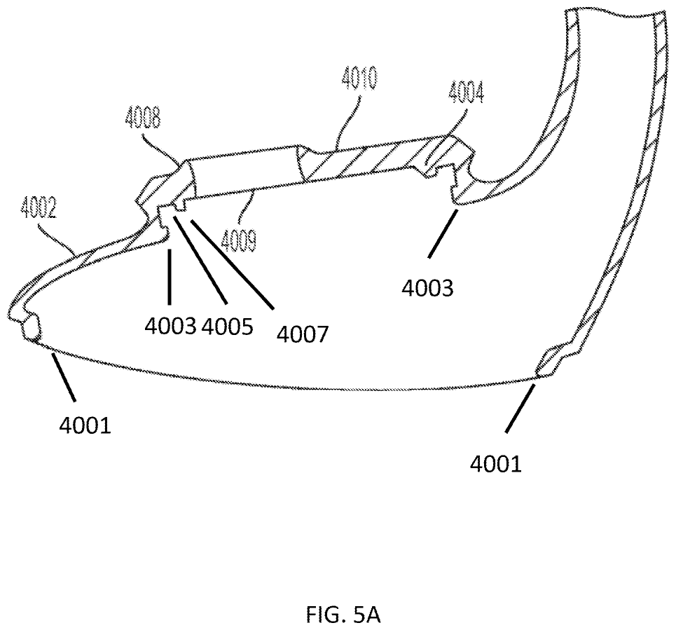

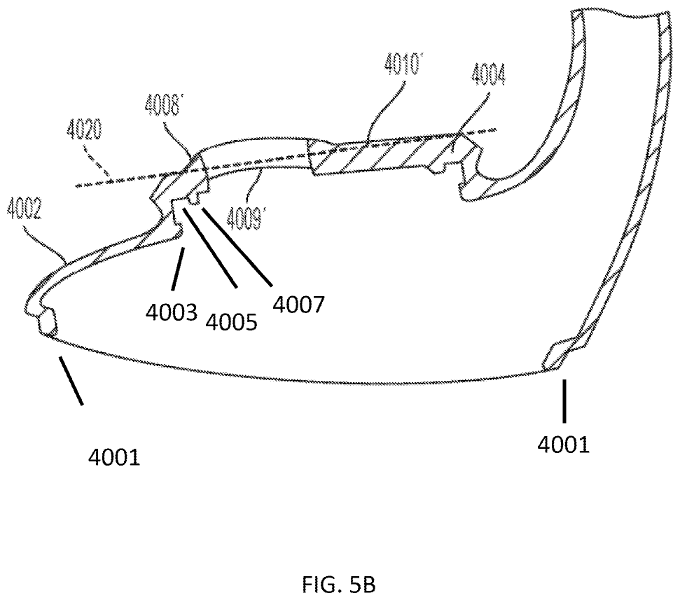

The cup may be embodied in a two-piece configuration. FIGS. 5A and 5B show a side cross-section view of the outer cup portion/sleeve of a two-cup configuration. FIG. 5A shows the top of the outer cup portion in an unswelled position, and FIG. 5B shows the top of the outer cup portion in a swelled position. In some embodiments, a height of the cavity of the cup increases (swells) from a first height to a second height, during a transition from a first volume to a second volume, and decreases (unswells) when transitioning back from the second volume to the first volume, or vice versa. In FIGS. 5A and 5B, outer cup portion 4004 is shown integral with sleeve 4002 and sleeve ridges 4003, 4005, which together surround a sleeve divot 4007. The sleeve ridges 4003, 4005, together with the sleeve divot 4007 ensure the outer cup portion 4004 is snuggly affixed to the remainder of the cup. The sleeve 4002 is further secured by a tail ridge 4001, which aid the outer cup portion 4004 in securing to the other cup portion.

The top of outer cup portion 4004 has lip 4008 and substantially-flat surface 4010. FIG. 5B shows the outer cup portion 4004 with surface 4010′, which is substantially-dome shaped, or “convex”. This is created due to the pressure in the chamber formed by inner cup portion (not shown) and outer cup portion 4004 inside the cavity. Dashed line 4020 represents where surface 4010 of FIG. 5A is before swelling (with swelled surface labeled 4010′). The change in the height of the surface between positions indicated by 4010 and 4010′, the undersurface 4009 and 4009′, and 4008 and 4008′ (if a lip is present) of the outer cup portion 4004 is result of vertical expansion and contraction.

Thus, in embodiments, the thickness of the top of the cup is configured and disposed to undergo vertical expansion and contraction during an operation cycle. This swelling and unswelling serves to mimic behavior of a human mouth engaged in oral sex with a vagina or vulva, serving to enhance the pleasure of the user during use of the device.

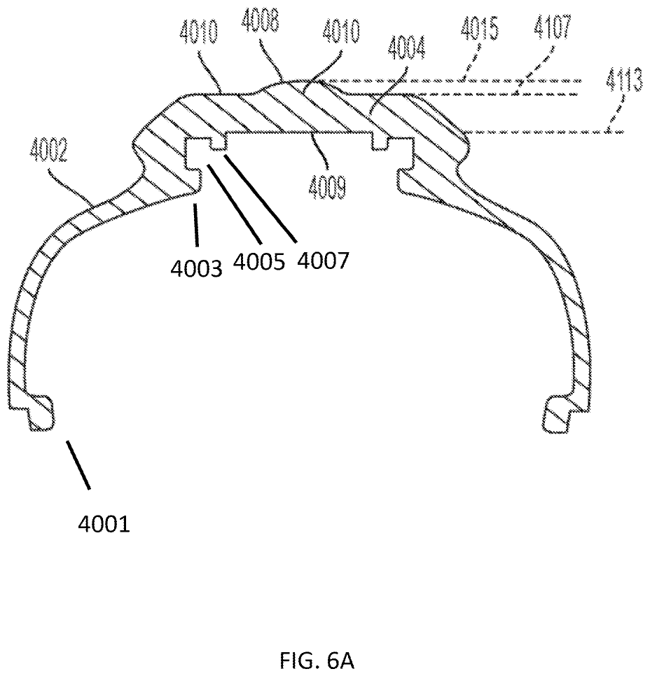

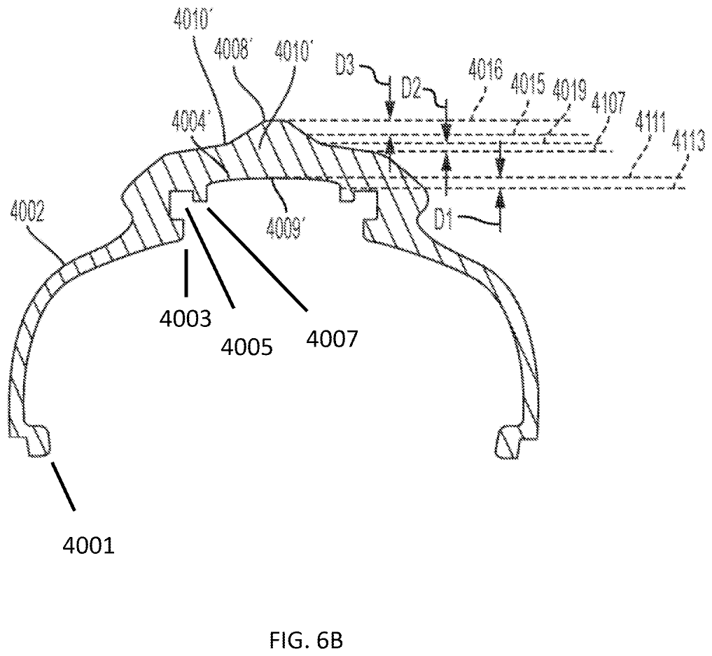

FIG. 6A shows a front cross-section view of an outer cup portion/sleeve (of a two-cup configuration) with the outer cup portion 4004 in unswelled configuration. Surface 4010 is shown substantially flat (or at rest) at a height denoted by line 4107, lip 4008 is at height 4015, and undersurface is at height denoted by line 4113. FIG. 6B shows a front cross-section view of the outer cup/sleeve with the surface 4010′ of the outer cup portion 4004′ in swelled configuration. Surface 4010′, undersurface 4009′, and lip 4008′ are shown swelled up.

Referring now also to FIG. 6B, the compressed (swelled) configuration heights are greater than the corresponding uncompressed (unswelled) configuration heights. Thus, swelled height 4111 of undersurface 4009′ is greater than height 4113 of undersurface 4009. In some embodiments, the difference (D1) between height 4111 and height 4113 ranges from 0.25 millimeters to 3 millimeters. In some embodiments, the height 4111 represents an increase of 5 percent to 8 percent as compared with height 4113. In some embodiments, the difference (D2) between height 4019 of unswelled surface 4010 and height 4107 of swelled surface 4010′ ranges from 0.25 millimeters to 3 millimeters. In some embodiments, the height 4019 represents an increase of 5 percent to 8 percent as compared with height 4107. In some embodiments, the difference (D3) between height 4015 of unswelled lip 4008 and height 4016 of swelled lip 4008′ ranges from 0.25 millimeters to 3 millimeters. In some embodiments, the height 4016 represents an increase of 5 percent to 8 percent as compared with height 4015. Note that these dimensions and values are examples, and other suitable dimensions and values are included within the scope of the invention where suitable in implementation of embodiments. The entire thickness (or substantially the entire thickness) of the top 4004 of the cup increases during swelling between 5-8% as noted by D1, D2, and D3, and decreases similarly during unswelling.

Referring to FIGS. 5A-6B, the top surface of the outer cup portion swells because the pressure increases as the bottom plate (or lifter, where plate is not present) reduces the volume in the chamber (when sealed). Top 105 of cup 102 (FIG. 1A) swells and unswells between inflection points the anchor walls 171 (like outer side walls) (no break is shown between the top 105 and anchor walls 171, but in some embodiments, there could be an attachment point between the two). The anchor walls do not buckle, or buckle only after the buckling region does.

The outer cup portion may be attached via ring, or other attachments known in the art.

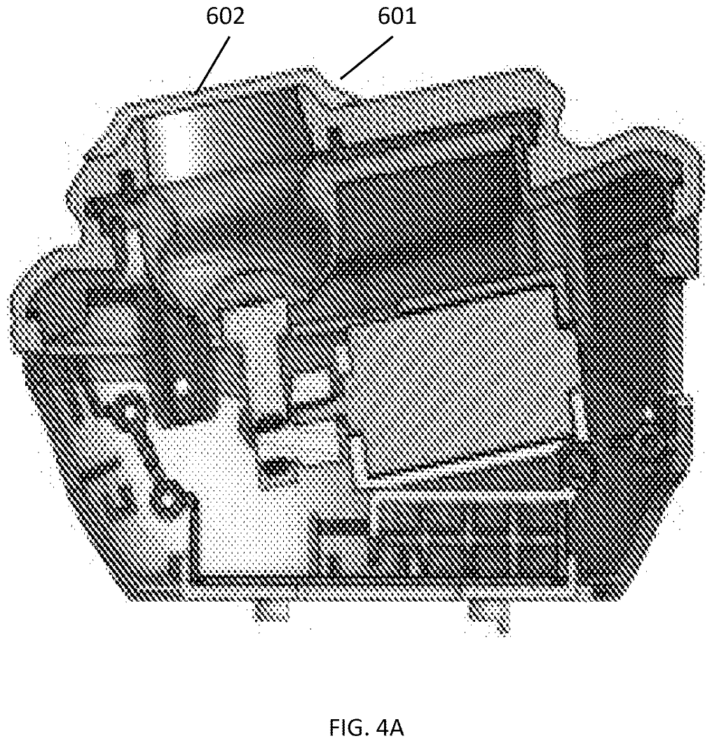

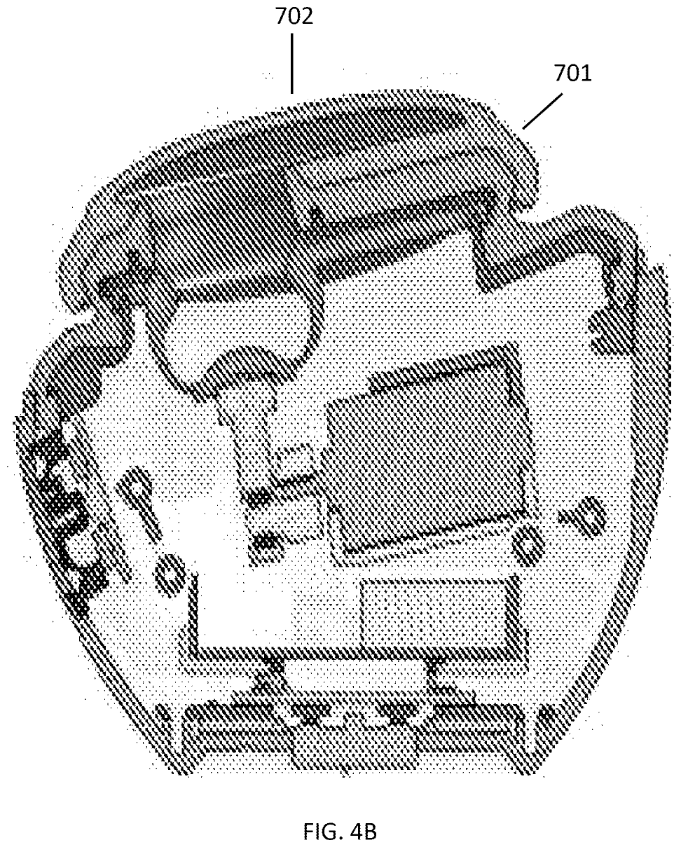

In some embodiments, as shown in FIG. 4A, an outer cup may additionally be fitted with a cap 601. The cap may be permanently affixed to the device. Alternatively, the cap may be removable an interchangeable with other caps of differing designs. The cap may be positioned over the outer cup and may be configured to have a flat surface 602. Other surface shapes may also be used, including convex or concave. FIG. 4B depicts an alternative embodiment in which a cap 701 is provided with a concave surface 702.

In some embodiments, as in FIG. 4A, the cap 601 may cover just a portion of the outer cup. Alternatively, as in FIG. 4B, the cap 701 may cover the entire outer cup.

The cap may be made of any flexible, resilient, waterproof material, as is understood in the art, and is preferably made of a silicone material. The device may also be made of plastic or any other suitable material. The cap further is preferably made of a material with elastomeric properties such that it can be fitted securely onto the top of the cup or on outer cup.

Note that although herein, a “chamber” is referred to, in some embodiments, the chamber is comprised of several separate but connected compartments, such that air can flow between the compartments. Accordingly, the use of the word “chamber” in the singular is not meant to exclude split-chamber or multi-chamber configurations. “Pressure” as used herein refers to air pressure.

In some embodiments, the cup 102 additionally has a wing region formed thereon. There may be side wings 118 a, 118 b on each side of the cup 102, as well as a front wing 118 c.

In use for stimulation of a vulva, front wing 118 c extends under the labia and under the mons pubis of a user to assist in holding the cup 102 to the skin of the user. This creates an improved seal of the chamber. Side wings 118 a and 118 b make contact with the labia during use for an improved seal and stimulation of the labia. Some embodiments may further include a basin 104 for improved seal.

FIG. 1B shows a front view of the cup 102 of FIG. 1A. In this view, the wing regions 118 a, 118 b, and 118 c are prominently shown. A buckle region wall 130 and an anchor wall 171 of cup 102 are in view. The buckle region wall 130 compresses and decompresses (i.e. expands/“springs out”) during operation of the stimulation device, resulting in a variable volume of the cavity 106 (FIG. 1) of cup 102. The anchor wall 171 serves as an anchor for the buckling of the buckle region wall 130. The buckle region wall 130 forms a resilient protrusion 159 that extends from the underside (floor) 147 of the anchor wall 171 of the cup 102. The buckle region wall 130 may be optionally covered with a cap. The cap may be concave, convex, or flat, depending on a user's preferences.

FIG. 1C is a side view of the cup 102 of FIG. 1A. The opposite side of the cup 102 looks symmetrical in embodiments. Referring also to FIG. 1B, the buckle region wall 130 forms a resilient protrusion 159, which is the buckle region, that extends from the underside 157 of the anchor wall 171 of cup 102.

FIG. 1D shows a rear view of the cup 102 of FIG. 1A. The buckle region wall 130 is in view with a first edge 139 and a second edge 137. First edge 139 is an upper exterior edge and second edge is a lower exterior edge (“exterior” is only used to denote that these edges are on the exterior of the cup, rather than interiorly inside the cavity). “Upper” and “lower” are used in describing in the orientation shown, but not mean to be limiting. Buckle region wall 130 protrudes from the underside 147 of the anchor wall 171 of cup 102, and forms the protrusion 159. Anchor wall 171 has a wall thickness larger than the wall thickness of buckle region wall 130.

FIG. 1E is a bottom-up view of the cup 102 of FIG. 1A. The buckle region is in view with the first edge 139 and the second edge 137 shown. A reveal R between edges 137 and 139 is configured to assist the buckle region wall in buckling under a compression force (also referred to herein interchangeably with “push force”) from a driver. The buckling of buckle region wall 130 typically occurs prior to any warping of anchor wall 171. In some embodiments, the anchor wall 171 does not buckle or warp. In some embodiments, the anchor wall 171 does not substantially buckle or warp. The buckle region wall 130 is also configured such that it will spring back out to default (i.e. extended/relaxed) position when the compression force is removed. The reveal “R” is the difference in the X and Y dimensions, between the edge 137 and the edge 139, as indicated in FIG. 1B, FIG. 1C, and FIG. 1E. In the embodiment shown, R is equal around the perimeters of edges 137 and 139. In other embodiments, R could have some irregularities.

In some embodiments, the buckle region wall 130 is concave in shape on its exterior surface. Thus, in some embodiments, the buckle region wall 130 has a concave exterior surface. In some embodiments, the first edge 139 is of a larger perimeter than the second edge 137. This creates the reveal R. In embodiments, the oval shape outlined by the second edge 137 is oriented concentrically with respect to the oval shape outlined by the first edge 139. In some embodiments, the buckle region wall 130 is formed with an oval shape as shown in FIG. 1E. In some embodiments, the buckle region is of a shape other than an oval. Any suitable shape is included within the scope of the invention.

The buckle region wall 130, with reveal R, is also configured such that it will spring back out to default (i.e. extended/relaxed) position when Vmax (maximum volume) is reached. The buckle region wall 130 is made of a material that allows the second edge 137 to be compressed towards the first edge 139 by a push force of a mechanical member of a driver toward Vmin (minimum volume). When then the push force is subsequently removed from the second edge 137, and instead the driver is pulling toward Vmax, the buckle region 137 quickly/abruptly returns to its default position (expanded position) with a spring-like motion. The buckle region behaves similar to a spring having a spring constant that causes the buckle region wall to abruptly return to its default position once the push force of the driver is removed. Thus, the thud force is a transfer of mechanical energy from the springing out of the buckle, which is imparted to the user through the cup. There is also very slight disengagement between the lifter slot and bearing as the cam rotates (discussed with respect to the driver herein)—rotating to compress and then again to return. In some embodiments, this contributes to the “thud” force. In some embodiments, the driver is configured to vary a volume of the cavity in such a way that the varied volume is not larger than an initial volume.

The cup 102 (and, therefore, cavity lateral wall 112 and base 114) is preferably comprised of a non-permeable flexible resilient material. In some embodiments, the flexible resilient material has a Shore durometer value ranging from A5 to D30. In some embodiments, the flexible resilient material has a Shore durometer value ranging from A10 to D20. In some embodiments, the cup is comprised of silicone. In some embodiments, the cup is comprised of rubber, TPE, plastic, or other suitable material.

In some embodiments, cup 102 may be formed without attachment to a sheath (referred to herein interchangeably with “sleeve”), and is glued or otherwise attached to a housing of a pressure field stimulation device. In other embodiments, the cup 102 may be attached to a sheath as shown and described in U.S. patent application Ser. No. 16/569,722 in FIGS. 25-26 and paras. [0155]-[0158]. Such portions of said patent application are herein incorporated by reference where not inconsistent with the disclosure herein.

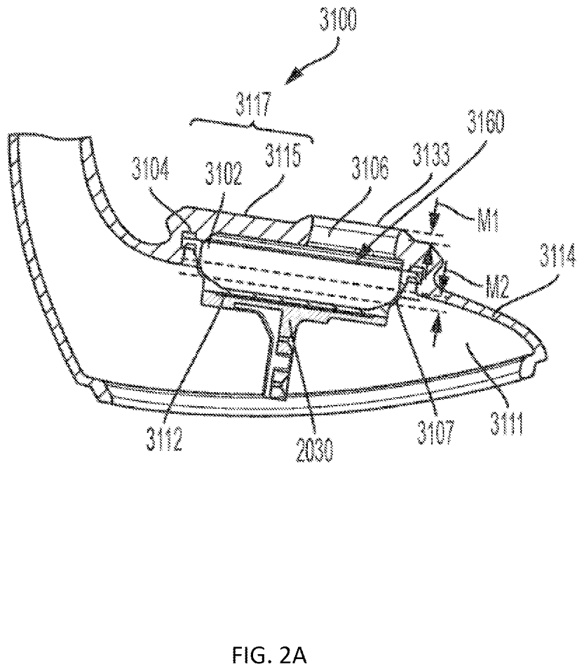

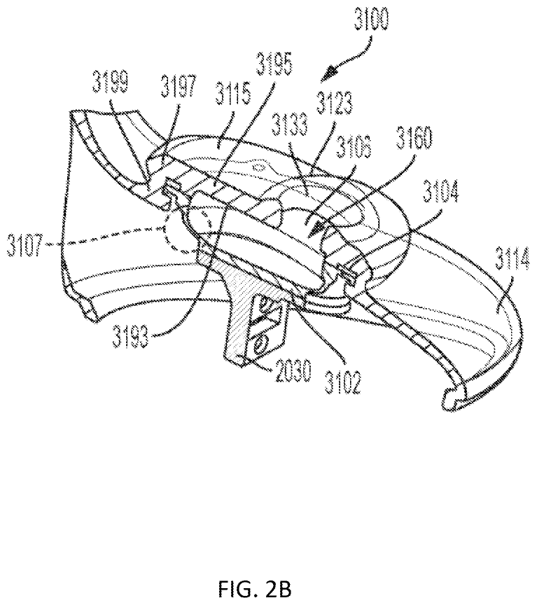

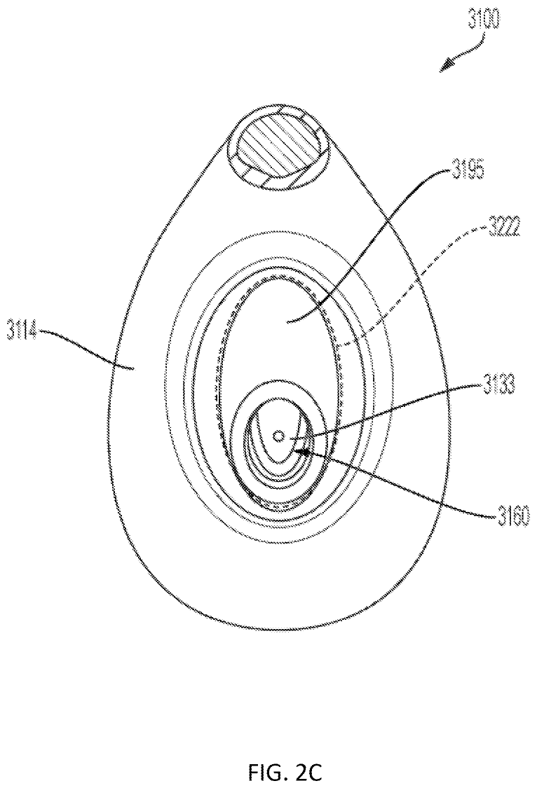

FIG. 2A and FIG. 2B show views of another cup assembly 3100 in accordance with some embodiments. For clarity, the housing is not shown in these figures. In some embodiments, the cup is comprised of an outer portion 3115 and an inner portion 3102. FIG. 2A shows a side cutaway view and FIG. 2B shows a perspective cutaway view. Referring now to FIG. 2A, the inner cup portion (referred to herein interchangeably with “diaphragm”) 3102 is disposed within an interior 3111 of the housing 3110 (not shown) In some embodiments, outer cup portion 3115 is integral (or, one piece with sleeve/sheath 3114). A chamber 3160 is formed by the outer cup portion 3115 and inner cup portion 3102 inside cavity 3106. Outer cup portion 3115 has opening 3133 into chamber 3160. The outer cup portion 3102 and the inner cup portion 3115 together form a seamless interior to the chamber, such that air can only be introduced or escape via the opening 3133.

In embodiments, a rigid plate 3112, as shown in FIG. 2A, is disposed below the inner cup portion 3102 to provide additional rigidity. Plate 3112 is not in view in FIG. 2B. In embodiments, rigid plate 3112 may be comprised of a hard plastic, metal, or other suitable material. In some embodiments, rigid plate 3112 may comprise aluminum or an aluminum alloy, or another suitable material. In some embodiments, the inner cup portion 3102 and outer cup portion 3115 are comprised of silicone. In some embodiments, the inner cup portion 3102 and outer cup portion 3115 are comprised of rubber, TPE, plastic, or other suitable material. The inner cup portion 3102 and outer cup portion can, but do not have to be made of the same material. In some embodiments, the plate is not present.

In some embodiments, the rim 3123 around the opening 3133 to cavity 3106 is formed, is raised a distance M1 as compared to the other rest of the outer portion 3115 of the cup, noted generally as 3117. In some embodiments, the distance M1 is a value ranging from 1.8 millimeters to 3.0 millimeters.

Inner cup portion 3102 has a buckle region 3107. Buckle region 3107 is convex on the exterior, which is different from the concave buckle region shown in the embodiment of FIGS. 1A-1E. During operation, buckle region 3107 of the inner cup portion 3102 buckles and/or flexes by a distance M2 due to the reciprocal motion of the lifter 2030 during operation. In some embodiments, distance M2 may range from 1.5 millimeters to 5.5 millimeters. In some embodiments, distance M2 may range from 1.5 millimeters to 6 millimeters.

Referring now to FIG. 2B, there can be seen the ring 3104 that holds the outer cup portion 3115 to the housing 3110 (not shown) above inner cup portion 3102. The outer cup portion 3115 is held by friction fit, glue, reciprocal grooves and indentations, or other suitable mechanism. Ring 3104 can be made of a rigid material, such as plastic, metal, or another suitable material. The outer cup portion 3115 has a top 3195, which extends to inflection point shown generally as 3197 to cup outer side walls 3199. Inflection point 3197 extends around the entire width of the cavity (so the cup top 3195 extends between “inflection points”, except where the opening is. Note that inflection point does not mean that there is a break in the material, but in some cases, there can be. Accordingly, it can also be called a “junction point” in some cases. In the example shown, the top surface and side walls 3199 are made of the same substantially contiguous material without a break in between. Top surface 3195 has an underside 3193, which is inside the cavity, opposite the top surface 3191. Region 3107 of the inner cup portion 3102 is the buckling region that is designed to buckle and/or flex to create changes in volume, and thereby, pressure within the cup during operation as the lifter 2030 moves in a reciprocal motion. The change in pressure during operation can create a pleasurable sensation for the user. “Top” used herein relating to the cup is not meant to be limiting. As consistent with the traditional usage of the word “cup,” the “top” is the portion which is open or has an opening therein. FIG. 2C shows a partial top-down view of the embodiment 3100 of FIGS. 2A and 2B. Reference number 3222 reflects the outline of the perimeter defining the width of the cavity under the cup top 3195.

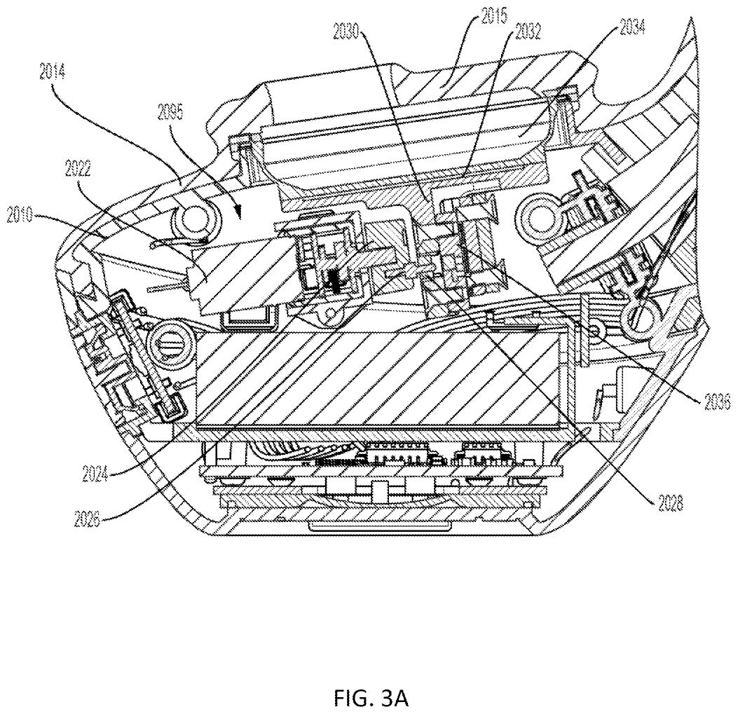

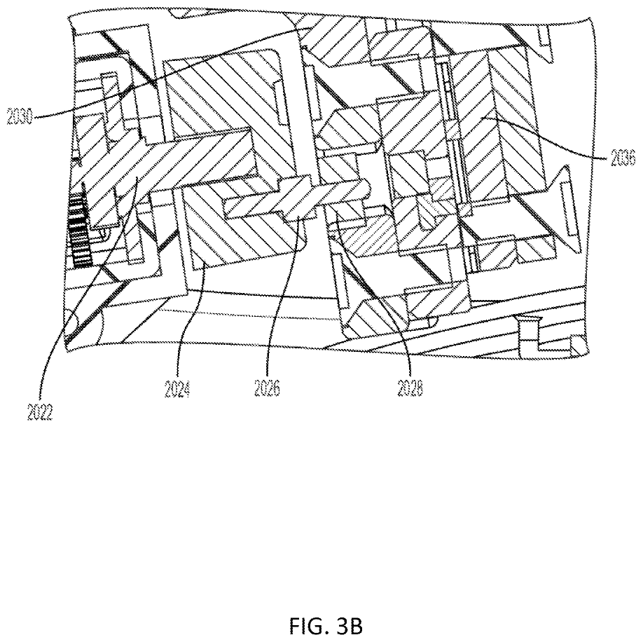

FIG. 3A shows a cutaway view of driver components, in addition to cup and sleeve components, of the pressure field stimulation device. The driver 2095 includes an electric motor 2022 that is configured and disposed to rotate a cam 2024. The cam 2024 has a cam pin 2026 protruding therefrom. A bearing 2028, which in some embodiments is a roller bearing as shown herein, is disposed on a distal end of the cam pin 2026. The cam pin 2026 is mechanically coupled to the bearing 2028. The roller bearing 2028 fits in a slot on the lifter 2030. The lifter 2030 is mechanically coupled to a rigid plate 2032. The rigid plate 2032 is mechanically coupled to the cup diaphragm 2034. In some embodiments, a non-rigid plate may be used in place of rigid plate 2032. The mechanism of the cam 2024, cam pin 2026, bearing 2028, and lifter 2030 convert rotational motion of the motor 2022 to a linear “up and down” motion for cyclically altering the volume, and thereby pressure, in the cup diaphragm 2034. To further stabilize and smooth the linear motion, a linear bearing 2036 is mechanically coupled to the lifter and configured and disposed to guide the motion of the lifter. The linear bearing constrains motion along a line, such that the lifter 2030 is constrained to only move along that line in a reciprocating manner. The linear bearing is shown in additional detail in FIG. 3B.

In some embodiments, the cam 2024 may be comprised of Polyoxymethylene (POM), aluminum, steel, or other suitable material. In some embodiments, the cam pin 2026 can be comprised of steel, plastic, a combination of steel and plastic, or other suitable material(s). In some embodiments, the roller bearing 2028 may be comprised of steel, plastic, a combination of steel and plastic, or other suitable material(s). In some embodiments, the linear bearing 2036 may be comprised of plastic, steel, a combination of steel and plastic, or other suitable material(s). In some embodiments, the rigid plate 2032 may be comprised of steel, plastic, and/or other suitable material(s).

Also in view are outer cup portion 2015 is in view, as well as sleeve 2014. Sleeve 2014 is disposed on housing 2010. Sleeve 2014 is attached to the housing 2010 either by friction fit, glue, reciprocal grooves and indentations, or other suitable mechanism.

FIG. 3B shows a diagram of additional details of the pressure field stimulation device indicating the linear bearing. As can be seen in FIG. 3B, the mechanism of the cam 2024, cam pin 2026, roller bearing 2028, and lifter 2030 convert rotational motion of the motor 2022 to a linear “up and down” motion, and the roller bearing 2028 serves to reduce friction, noise, and unwanted vibration of the mechanism. The linear bearing 2036 is mechanically coupled to the lifter to guide the motion of the lifter in a smooth motion that reduces noise and vibration.

Some embodiments are waterproof such that they may be washed with fluids, like soap and water. Accordingly, the attachment points of the sheath and any other external portions are sealed where necessary. This allows a user to clean the device thoroughly between insertions. In embodiments, the pressure field stimulation device is unitary in structure, meaning the components thereof together form a single product, rather than multiple products which may be used together by a user.

As can now be appreciated, disclosed embodiments provide an improved pressure field stimulation device utilizing a driver including a combination of roller bearings and linear bearings to create a smooth reciprocating motion. This approach reduces unwanted noise and vibration, and provides for an improved user experience. Note that the driver is not limited to working with the cups disclosed herein, and other cups can be substituted where feasible.

Disclosed embodiments also provide an improved pressure field stimulation device with a cup that expands and contracts. Note that the cups are not limited to working with the disclosed drivers, and other drivers can be substituted where feasible.

While the invention has been particularly shown and described in conjunction with exemplary embodiments, it will be appreciated that variations and modifications will occur to those skilled in the art. The embodiments according to the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of the invention.

What is claimed is:

1. A stimulation device, comprising:
a cup formed of a flexible resilient material, and having a cavity, wherein a top of the cup is joined with outer side walls of the cup;
a driver;
a processor; and
a memory containing instructions that when executed by the processor cause the driver to vary a volume of the cavity of the cup from a first volume to a second volume;
wherein the top of the cup is configured to swell on a surface extending between inflection points during variation from the first volume to the second volume;
wherein the top of the cup is configured to unswell on the surface during variation from the second volume to the first volume;
wherein the cup has a bottom base;
wherein the top has an opening thereon;
wherein the top extends over the entire width of the cavity, except where the opening is disposed;
wherein the opening has a cap; and
wherein the cap substantially covers the opening.

2. The device of claim 1 wherein the cap is removable.

3. The device of claim 1 wherein the cap is made of silicone.

4. The device of claim 1 wherein the cap has a physical texture on an outer surface thereof.

5. The device of claim 4 wherein the texture is ribs or bumps.

6. The device of claim 1 wherein the cap seals off a sealed chamber.

7. The device of claim 6 wherein changes to the interior pressure of the sealed chamber causes the cap to expand or contract.

8. The device of claim 1 wherein the device is adapted to mimic human contact.

9. The device of claim 7 wherein the device is adapted to mimic human contact.

10. The device of claim 1 wherein the cap has a flat top surface substantially the same area as the opening.

11. The device of claim 1 wherein the cap covers substantially the entirety of the top of the cup.

12. A stimulation device, comprising:
a cup formed of a flexible resilient material, and having a cavity, wherein a top of the cup is joined to side walls of the cup;
a driver;
a processor; and
a memory containing instructions that when executed by the processor cause the driver to contract and expand a volume of the cavity of the cup;
wherein the top of the cup is configured to swell on a surface extending between inflection points during contraction;
wherein the top of the cup is configured to unswell on the surface during expansion;
wherein the cup has a bottom base;
wherein the top has an opening thereon;
wherein the top extends over the entire width of the cavity, except where the opening is disposed;
wherein the top of the cup has a cap; and
wherein the cap substantially covers the top of the cup.
The device of claim 1 wherein the cap is removable.

13. The device of claim 12 wherein the cap is made of silicone.

14. The device of claim 12 wherein the cap has a physical texture on an outer surface thereof.

15. The device of claim 14 wherein the texture is ribs or bumps.

16. The device of claim 1 wherein the cap seals off a sealed chamber.

17. The device of claim 16 wherein changes to the interior pressure of the sealed chamber causes the cap to expand or contract.

18. The device of claim 1 wherein the device is adapted to mimic human contact.

19. The device of claim 17 wherein the device is adapted to mimic human contact.

20. A stimulation device, comprising:
a cup formed of a flexible resilient material, and having a cavity, wherein a top of the cup is joined to side walls of the cup;
a driver;
a processor; and
a memory containing instructions that when executed by the processor cause the driver to contract and expand a volume of the cavity of the cup;
wherein the top of the cup is configured to swell on a surface extending between inflection points during contraction;
wherein the top of the cup is configured to unswell on the surface during expansion;
wherein the cup has a bottom base;
wherein the top has an opening thereon;
wherein the top extends over the entire width of the cavity, except where the opening is disposed;
a removable cap that covers at least a portion of the top of the cup, wherein the cap has an outer texture and seals off a sealed chamber, and wherein changes to the interior pressure of the sealed chamber causes the cap to expand or contract to mimic human contact.
